(19) United States
(12) Patent Application Publication
(10) Pub. No.: US 2013/0011325 A1
(43) Pub. Date: Jan. 10, 2013

(54) Process For The Production Of Hydrogen And Carbon Dioxide Utilizing Dry Magnesium Based Sorbents In A Fixed Bed

(75) Inventor: Bhadra S. Grover, Sugar Land, TX (US)

(73) Assignee: L'Air Liquide Societe Anonyme Pour L'Etude Et L'Exploitation Des Procedes Georges Claude, Paris (FR)

(21) Appl. No.: 13/176,566

(22) Filed: Jul. 5, 2011

(51) Int. Cl. C01B 31/20

(52) U.S. Cl. 423/437.1

(57) ABSTRACT

The present invention relates to a process for recovering hydrogen along with high temperature high pressure carbon dioxide from one or more hydrocarbon gas streams by incorporating a carbon dioxide recovery unit which utilizes a magnesium based sorbent into a process that includes a gasification unit, an optional sulfur removal unit, a water gas shift reactor and a hydrogen pressure swing adsorption unit.

### FIELD OF THE INVENTION

The present invention relates to an energy efficient process for recovering hydrogen along with high temperature, high pressure carbon dioxide utilizing a high pressure syngas gasification unit, an optional sulfur removal unit, a water gas shift reactor, one or more sorbent beds containing a magnesium based sorbent, and a pressure swing adsorption unit.

### BACKGROUND

A number of different products have been proposed for use in prior art methods for the removal of carbon dioxide. However, most of the products used have to be regenerated at low pressure thereby resulting in the production of a carbon dioxide stream that is at low pressure. For example, U.S. Pat. No. 6,322,612 describes a pressure swing adsorption process for carbon dioxide removal. However, carbon dioxide is produced at low atmospheric or sub-atmospheric pressure. Solvent scrubbing processes such as the amine scrubbing process requires gas cooling below 40° C. thereby resulting in a loss of thermal efficiency. Sorbents such as zeolites have their capacities lowered at temperatures above about 200° C., and are strongly affected by the presence of moisture. In addition, sorbents such as calcium based sorbents and lithium based sorbents have been shown to adsorb carbon dioxide within the 200° C. to 400° C. temperature range but must be regenerated at low pressure and much higher temperatures (from 700° C. or greater) thereby requiring a large amount of regeneration energy.

New sorbents have been proposed for the removal of carbon dioxide. The publication “Novel Regenerable Magnesium Hydroxide Sorbent for CO₂ Capture at Warm Gas Temperatures” by Rajani V Siriwardane and R. W Stevens of NETL describes a sorbent based on Mg(OH)₂ that can capture carbon dioxide at temperatures from 200° C. to 315° C. and can regenerate carbon dioxide at 20 bar and from 375° C. to 400° C. The noted article indicates that this sorbent may be used in applications such as coal gasification systems. U.S. Pat. No. 7,314,847 sets forth a process for preparing this sorbent. These sorbents produce CO₂ streams at elevated pressure and temperature, however the CO₂ stream needs further treatment to remove contaminants.

Accordingly, while there are a variety of different sorbents and different processes for removing carbon dioxide, there still exists a need to provide for a process that allows for the economical recovery of hydrogen as well as carbon dioxide where it is possible to remove the carbon dioxide at high pressure and high temperature.

### SUMMARY OF THE INVENTION

The present invention relates to a process for recovering hydrogen along with high temperature high pressure carbon dioxide from one or more hydrocarbon feed streams by incorporating a carbon dioxide recovery unit which utilizes a magnesium based sorbent into a process that includes a gasification unit, an optional sulfur removal unit, a water gas shift reactor and a pressure swing adsorption unit. By incorporating such a carbon dioxide recovery unit into such a process, it makes it possible to provide a more economical recovery of carbon dioxide, thereby improving the overall economics of hydrogen and carbon dioxide production.

### BRIEF DESCRIPTION OF THE FIGURES

FIG. 1 provides a schematic of the process of the present invention.

### DETAILED DESCRIPTION OF THE INVENTION

The process of the present invention provides for the incorporation of a sorbent based carbon dioxide removal unit into a process for the production of hydrogen and high temperature and high pressure carbon dioxide in order to improve the overall efficiency of the process through the phases of sorption, purge, carbon dioxide release and rehydroxylation. This process also includes a high pressure gasification unit, an optional sulfur removal unit, a water gas shift unit and a pressure swing adsorption unit. By incorporating this sorbent based carbon dioxide removal unit between the water gas shift unit and the hydrogen pressure swing adsorption unit, it is possible to effectively remove the carbon dioxide present in the water gas shift effluent to produce a concentrated carbon dioxide product that is produced at high pressure/high temperature. In addition to producing a concentrated carbon dioxide product, during the purge of the sorbent beds, the sorbent beds are purged with high pressure steam to remove the hydrogen, carbon monoxide and methane trapped in the void spaces of the sorbent, with the pressure of the steam used being of sufficient degree to enable this hydrogen, carbon monoxide and methane containing stream (hereinafter “purge stream”) to be recycled as a supplemental feed for the water gas shift reactor. The amount of steam used for purging the bed correspondingly reduces the amount of steam added to the water gas shift reactor. This presents the further advantage of no net steam utilized for purging. The recycle of hydrogen, carbon monoxide and methane at high temperature improves the overall efficiency of the hydrogen production. The purge phase of the carbon dioxide removal step improves the purity of the carbon dioxide stream, which is important if part of the carbon dioxide stream is used elsewhere as a product. Note that the pressure during the purge phase is higher than the pressure during the sorption phase.

Following the purge phase, the sorbent bed is depressurized to the desired level and further heated to desorb the pure carbon dioxide at the desired pressure. The resulting carbon dioxide depleted stream obtained as a part of these process steps is passed along to a pressure swing adsorption unit for producing a high purity stream of hydrogen. These process steps in turn maximize the use of energy contained in streams produced during the sorption phase of the carbon dioxide removal step while minimizing the additional treatment often necessary for use of the various streams produced according to conventional processes.

The process of the present invention involves recovering high purity hydrogen and high purity carbon dioxide from one or more hydrocarbon feed streams utilizing a high pressure gasification unit in combination with an optional sulfur removal unit, a water gas shift reactor, a carbon dioxide removal unit comprising one or more sorbent beds and a pressure swing adsorption unit. As used herein, the phrase “high purity carbon dioxide” refers to a carbon dioxide stream that contains greater than 90% carbon dioxide, preferably greater than 95% carbon dioxide and even more preferably, greater than 99% carbon dioxide. Furthermore, as used herein, the phrase “high purity hydrogen” refers to a hydrogen stream that contains greater than 90% hydrogen, preferably greater than 95% hydrogen and even more preferably, greater than 99% hydrogen.

More specifically, the process involves introducing one or more hydrocarbon feed streams into a gasification unit to generate a syngas stream, optionally treating the syngas stream in a sulfur removal unit (when the syngas stream is a sour syngas stream) to produce an essentially sulfur free syngas, treating syngas stream in a water gas shift reactor to obtain a water gas shift effluent, subjecting the water gas shift effluent to treatment in a carbon dioxide removal unit containing one or more sorbents beds to produce a carbon dioxide depleted stream, an optional purge effluent gas and a carbon dioxide rich stream, introducing the carbon dioxide depleted stream into a hydrogen pressure swing adsorption unit to allow for the recovery of hydrogen, recycling the purge effluent gas to be recycled to the water gas shift reactor, and withdrawing all or part of the carbon dioxide as product.

Those of ordinary skill in the art will recognize that the carbon dioxide depleted stream and the purge effluent gas may also contain residual amounts of carbon dioxide as well as the other components that may be present in the original gas stream treated. As used herein, the phrase “residual amounts” when referring to the amounts of other components that may be present in the carbon dioxide depleted stream refers collectively to an amount that is less than about 5.0%, preferably less than about 3.0% and even more preferably less than about 1.0%.

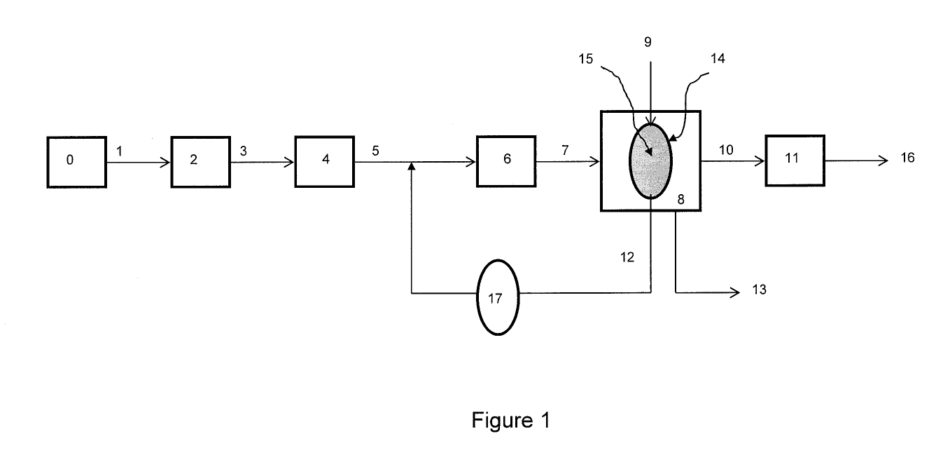

The process will be further described in more detail with reference to the single FIGURE contained therein (FIG. 1). Note that this FIGURE is not meant to be limiting with regard to the present process and is included simply for non-limiting illustrative purposes. In addition, the present process includes two subembodiments: one that includes a sulfur removal unit when the syngas is a sour syngas stream and another that does not include a sulfur removal unit when the syngas is a sweet syngas stream.

The first step of the present process, as shown in FIG. 1, involves generating a syngas stream by treating one or more hydrocarbon feed streams in a gasification unit 2, the one or more hydrocarbon feed streams being obtained from a source 0 via line 1. The high pressure gasification unit 2 contemplated for use in the present invention is any gasification unit 2 known in the art which is capable of processing hydrocarbon feed streams in order to produce a syngas stream that also contains at least hydrogen and carbon dioxide. Furthermore, as used herein, the phrases “hydrocarbon feed”, “hydrocarbon feeds”. “hydrocarbon feed stream” or “hydrocarbon feed streams” refer to any solid or liquid fuel or solid or liquid fuel source which is derived from organic materials such as refinery residue materials (for example, tar, heavy oils, petcoke, coke) or coal or biofuels (for example, wood, peat, corn, corn husks, wheat, rye and other grains), crude oil, coal or natural gas. In the preferred embodiments of the present invention, the hydrocarbon feed streams 0 are preferably selected from refinery residues, coal and biofuels. Gasification units 2 such as those proposed for the present process are readily known to those skilled in the art. Accordingly, the present process is not meant to be limited to a specific gasification unit 2 or the process for carrying out the reaction in the gasification unit 2.

With regard to the gasification units 2, the desire is to produce a syngas stream that is rich in hydrogen, carbon monoxide, and carbon dioxide as these are the ultimate products. However, depending upon the original hydrocarbon fuel source utilized, the final syngas stream produced in the gasification units 2 may include a variety of other components such as, but not limited to, sulfur containing compounds and nitrogen containing compounds that are produced in the gasification unit 2. Syngas streams that contain such compounds are typically referred to as sour syngas streams.

When the syngas stream is a sour syngas stream, is desirable to remove at least the sulfur containing compounds from the sour syngas stream upstream of the carbon dioxide removal unit 8 as the sulfur compounds can cause problems with the magnesium based sorbent. Note that there is a sour water gas shift that works with sulfur containing sour gas. However, the operating conditions for the sour water gas shift can be different from the sweet (no sulfur) water gas shift. Those skilled in the art can make an economic choice of using sour water gas shift or sweet water gas shift. Accordingly, depending upon the choice, the sulfur removal unit can be upstream or downstream of the water gas shift. For purposes of the present invention, the discussion focuses on the sweet water gas shift reactor (where the sulfur is removed before the stream is introduced into the water gas shift reactor). Note for treatment of syngas streams that are produced without the presence of sulfur containing compounds, the sulfur removal unit is not necessary.

In the next step of the process, the sulfur containing compounds in the sour syngas stream are removed prior to the sour syngas stream being injected into the water gas shift reactor 6 by introducing the sour syngas stream into a sulfur removal unit 4.

Depending upon the sulfur removal process utilized, the syngas exiting the gasification unit 2 may need to be cooled before it can be further processed. Those skilled in the art recognize that there are various ways that the syngas can be cooled or quenched. The present invention is not meant to be limited by this means of cooling/quenching. Accordingly, the cooling of the syngas is not shown in the FIG. 1. However, it is desirable to remove the sulfur containing compounds at high temperature of from about 250° C. to about 400° C., as compared to conventional amine processes that operate at lower temperatures of from about 30° C. to about 70° C., to avoid cooling the syngas for sulfur removal and reheating it for the water gas shift reaction as such cooling and reheating results in the need for extra steps, extra energy and extra costs. One process for removing sulfur containing compounds from sour syngas is described in NETL Project Facts “Integrated Warm Gas Multicontaminant Cleanup Technologies for Coal-Derived Syngas”. Accordingly, such a process or a similar process allowing for the removal of sulfur containing compounds without the need to cool the sour syngas is preferred. Note the present process is not meant to be limited to a sulfur removal unit 4 or the process for carrying out the reaction in the sulfur removal unit 4. As a result of the removal of the sulfur, an essentially sulfur free syngas stream is produced. As used herein, the phrase “essentially sulfur free” when used in terms of the syngas stream refers to a syngas stream that comprises less than 10 ppm of sulfur containing compounds, preferably less than 1 ppm sulfur containing compounds.

After the sulfur is removed from the sour syngas stream to produce an essentially sulfur free syngas stream, this essentially sulfur free syngas stream is treated in a water gas shift reactor 6 to further enrich the hydrogen content of the essentially sulfur free syngas stream and to also increase the carbon dioxide content in the essentially sulfur free syngas stream by oxidizing a portion of the carbon monoxide present in the essentially sulfur free syngas stream to carbon dioxide thereby obtaining a water gas shift effluent. In this embodiment, the essentially sulfur free syngas stream is introduced via line 5 into the water gas shift reactor 6 (which can contain a variety of stages or one stage; stages not shown) to form additional hydrogen and carbon dioxide. Note that additional steam may also be added (not shown) upstream of the water gas shift reactor 6 along line 5. The result is a water gas shift effluent that is also at high temperature and high pressure. The conditions under which water gas shift reaction is carried out are well known to those skilled in the art. Accordingly, the present process is not meant to be limited to a specific water gas shift reactor 6 or the process for carrying out the reaction in the water gas shift reactor 6. Accordingly, any water gas shift reactor 6 known in the art may be used in the process of the present invention.

In the next step of the present process, the water gas shift effluent that is obtained from the water gas shift reactor 6 is subjected to treatment in a carbon dioxide removal unit 8 that contains at least one fixed sorbent bed (only one bed depicted in FIG. 1) for the removal of carbon dioxide. As used herein, the phrases “fixed bed” or “fixed sorbent bed” refer to a sorbent bed 14 in which the sorbent 15 is fixed or positioned within the bed 14 in such a manner that the sorbent 15 does not readily move about within the sorbent bed 14 when the water gas shift effluent from line 7 is injected into the sorbent bed 14 (hence the term “fixed”). The carbon dioxide removal step is a batch process, and as the fixed bed 14 approaches being loaded with the desired amount of carbon dioxide, the feed can be switched over to the next fixed bed 14.

Typically, multiple fixed sorbent beds 14 that are manifolded together are provided to go thru the various phases of sorption, purge, release and rehydroxylation. These fixed beds 14 may also be provided with heat transfer surfaces (not shown) to provide or take away the heat from the process. Those skilled in the art will realize that this can be done in a number of different manners. Accordingly, the present invention is not meant to be limited to any one configuration for the fixed sorbent beds 14 provided that the sorbent beds 14 include fixed sorbent 15 and provide one or more mechanisms for injecting/withdrawing the various gas streams (for example, the beds would include one or more flow reversible conduits which allow for the flow of gas in both directions; not shown in FIG. 1).

Accordingly, as used herein with regard to the present process, the term “fixed sorbent bed” or the plural thereof refers to any device that is designed to hold a fixed sorbent 15 while allowing for the injection and flow through of a water gas shift effluent from one side of the fixed sorbent bed 14 (functioning as an entrance) to the other side of the fixed sorbent bed 14 (functioning as an exit). The sorbent 15 is positioned within the confines of the fixed sorbent bed 14. With regard to the fixed sorbent beds 14, each fixed sorbent bed 14 allows for the injection of a product from line 7 (in this case the water gas shift effluent) into the fixed sorbent bed 14 and the exit of a stream that is essentially carbon dioxide free via line 10. As used herein, the phrase “essentially carbon dioxide free” refers to a stream that contains less than about 1.0% carbon dioxide, preferably less than about 0.5% carbon dioxide and even more preferably, less than about 0.1% carbon dioxide. However, as noted before, those skilled in the art will recognize that these streams often contain residual amounts of other components that may be present in the original syngas stream to be treated as well. Accordingly, as noted hereinbefore, the amount of the components will typically be present in the residual amount of less than 5.0%, preferably less than 3.0% and even more preferably less than 1.0%.

The sorbent 15 that is utilized in the one or more fixed sorbent beds 14 of the process of the present invention is highly selective for carbon dioxide and is selected from magnesium based sorbents, more particularly, magnesium hydroxide sorbents. As used herein, the sorbent is in the form of a bed that contains beads, granules, crumbs or pellets of the sorbent 15. Of these sorbents 15, the most preferred with regard to the present process are the magnesium hydroxide sorbents such as those that are disclosed in U.S. Pat. No. 7,314,847 and Nobel Regeneration Magnesium Hydroxide Sorbent for CO2 Capture, the full contents of each incorporated herein.

The fixed sorbent bed 14 retains the carbon dioxide because of the chemical reaction (adsorption) of the carbon dioxide with the sorbent 15. In addition, because of the manner in which the sorbent 15 is placed within each bed 14, there becomes spaces or voids due to the positioning of the sorbent particles 15 (the spaces created when the sorbent particles are in proximity to one another). Typically components such as hydrogen, carbon monoxide and methane will non-specifically fill or become trapped within the void spaces of the sorbent 15. These non-specifically filled or trapped components are then removed during the purge phase via line 12 as shown in FIG. 1. When the carbon dioxide removal unit 8 contains more than one bed 14, the specific bed 14 into which the water gas shift effluent is injected can be controlled through the use of a variety of valves and lines (not shown).

The actual treatment of the water gas shift effluent in the one or more fixed sorbent beds 14 involves four phases: the sorption phase, the purge phase, the carbon dioxide release phase and the rehydroxylation phase. The first of these phases, the sorption phase, involves introducing the water gas shift effluent into one or more fixed sorbent beds 14 in the carbon dioxide removal unit 8 thereby allowing for the carbon dioxide in the water gas shift effluent to selectively react with the sorbent 15 as the water gas shift effluent passes though the fixed sorbent bed 14. Note that the temperature at which the water gas shift effluent in introduced into the one or more sorbent beds 14 will depend upon the specific sorbent 15 utilized as well as the conditions under which the water gas shift reaction are carried out. Typically, the water gas shift effluent will be introduced into the one or more fixed sorbent beds 14 at a temperature from about 100° C. to about 315° C. and at a pressure from about 20 bar to about 60 bar. Preferably, with regard to the present process, the water gas shift effluent will be introduced into the one or more sorbent beds 14 at a temperature that ranges from about 100° C. to about 250° C. and at a pressure from about 20 bar to about 60 bar. With regard to this reaction, the sorbent 15 reacts with the carbon dioxide in the water gas shift effluent to produce a carbonate and water. For example, in the case of magnesium hydroxide the reaction is:

Mg(OH)₂+CO₂→MgCO₃+H₂O

The magnesium hydroxide reacts with the carbon dioxide to yield magnesium carbonate and water. While a majority of the carbon dioxide present in the water gas shift effluent will react with the magnesium hydroxide sorbent to form a carbonate, a small amount of the carbon dioxide will remain unreacted. Generally greater than 90% of the carbon dioxide in the water gas shift effluent will be removed from the water gas shift effluent stream by the sorbent 14, preferably greater than 95% and even more preferably greater than 99%.

As noted previously, void spaces are created in the fixed sorbent bed 14 due to sorbent particle size and shapes (either as beads, granules, crumbs or pellets). These void spaces cause the non-specific “trapping” of components of the water gas shift effluent. The remaining components of the water gas shift effluent that are not trapped in the void spaces of the sorbent are discharged from the fixed sorbent bed 14 via line 10 as a carbon dioxide depleted stream which can be further treated to obtain a hydrogen rich stream as described hereinbelow. As used herein with regard to the sorption phase, the phrase “remaining components” refers to hydrogen, carbon monoxide, methane, water vapor and other components as defined hereinbefore. In addition, the remaining components may also include a small amount of carbon dioxide that does not react with the sorbent 15 and becomes trapped in the void spaces. This carbon dioxide depleted stream is then passed to the hydrogen pressure swing adsorption unit 11 in order to remove the hydrogen present as a high purity hydrogen product stream via line 16.

Note that the period of time that the water gas effluent stream passes through the fixed sorbent bed 14 will depend upon the particular sorbent 15 utilized. As used herein, with regard to the sorption phase, the term “capacity” and phrase “high capacity” each refer to the amount of carbon dioxide that the sorbent 15 will remove from the water gas shift effluent stream. More specifically, the term “capacity” and phrase “high capacity” each refer to the amount of reactive sites (hydroxyl sites) of the sorbent 15 that react with carbon dioxide.

The next phase in the treatment of the water gas shift effluent in the carbon dioxide removal unit 8 is the purging of the fixed sorbent bed 14. As the sorbent 15 becomes saturated due to the carbon dioxide capacity of the sorbent 14 being reached (or almost being reach), the introduction of the water gas shift effluent stream into the sorbent bed 14 is stopped and high pressure superheated steam is injected into the fixed sorbent bed 14 through line 9. Note that at this point the pressure of the superheated steam used to purge the fixed sorbent bed 14 will be such that the purge stream created is at pressure higher than the pressure at the inlet of the water gas shift reactor 6. This will allow the purge stream obtained to flow along line 12 to line 5 before being introduced along with the essentially sulfur free syngas stream into the water gas shift reactor 6 without any additional compression. Note that a purge surge drum 17 may also optionally be included along line 12 to allow for the mixing of the purge stream for a more consistent stream. The superheated steam pressure utilized generally ranges from about 20 bar to about 70 bar.

Those skilled in the art will recognize that the flow through the sorbent beds 14 can be controlled through strategically placed valves and lines. Furthermore, those skilled in the art will recognize that this embodiment may be carried out with regard to any number of fixed sorbent beds 14. In the preferred embodiment of the present process, the schematic configuration utilized with regard to the carbon dioxide removal unit 8 is a configuration that contains two or more fixed sorbent beds 14. More specifically, this embodiment can be carried out and from two to eight fixed sorbent beds 14. Accordingly, in such a configuration rather than terminating the introduction of the water gas shift effluent into the fixed sorbent bed 14, the stream is simply diverted to another fixed sorbent bed 14 which is in the sorption phase of the four phases of the treatment in the carbon dioxide removal unit 8. Therefore, in such configurations, it is possible to use multiple fixed sorbent beds which are staggered with regard to one another in terms of these four phases. By way of example, the configuration may include eight total fixed sorbent beds 14 with two fixed sorbent beds 14 running parallel to one another and being in the sorption phase at the same time, two fixed sorbent beds 14 being in the purge phase at the same time, two fixed sorbent beds 14 being in the carbon dioxide release phase at the same time and two fixed sorbent beds 14 being in the rehydroxylation phase at the same time.

Those skilled in the art can see that cycle sequence and step time can be tailored in many different ways to satisfy transfer of heat as well as transfer of carbon dioxide molecules. By using a configuration which is the same or similar in nature to this, it is possible to constantly run the process without the need to interrupt the process. In other words, it's possible to run the process online continuously.

During the purge phase, the superheated steam injected into the fixed sorbent bed 14 serves to dislodge a large portion of the remaining components that are trapped or lodged in the void spaces of the sorbent 15, thereby producing a purge effluent gas (also referred to as a purge stream) which contains these dislodged components. This purge effluent gas is withdrawn from the fixed sorbent bed 14 for example through a reversible flow conduit (not shown) and recycled via line 12 along with the superheated steam used to dislodge these components to the syngas stream 5 that is to be introduced into the water gas shift reactor 6. This purge effluent gas which contains hydrogen, carbon monoxide and methane is used as a supplemental feed to maximize the production of hydrogen and carbon dioxide. This superheated steam is introduced into the fixed sorbent bed 14 and allowed to pass through the fixed sorbent bed 14 (for example, from one side to the opposing side of the sorbent bed 14). It is important to control this step as excess steaming will heat up the fixed sorbent bed 14 and start the release of the carbon dioxide from the sorbent 15 due to the decomposition of the carbonate. For example, MgCO₃ starts decomposition at from about 350° C. to about 400° C. depending upon the pressure of the sorption bed 14. Those skilled in the art will recognize that higher pressures need higher temperatures for decomposition to start.

The composition of the purge gas will vary during the purge phase, being rich in hydrogen, carbon monoxide, methane in the beginning of the purge, and being lean in these components towards the end of the phase. A purge gas drum 17 is provided along line 12 to smooth out the composition and flow of recycle stream to the water gas shift reactor 6.

The next phase of the treatment in the carbon dioxide removal unit 8 is the carbon dioxide release phase which provides a high purity carbon dioxide stream that is also at high pressure and high temperature. This is accomplished by first increasing the temperature of the fixed sorbent bed 14. This increase in temperature of the fixed sorbent bed 14 may be accomplished in one of two manners. The temperature of the superheated steam stream provided via line 9 can be increased or additional heating means such as an indirect heat exchanger (not shown) may be used to increase the temperature of the sorbent from about 180° C. to about 315° C. to from about 350° C. to about 420° C. In each of these cases, the temperature is increased to allow for the release of carbon dioxide from the sorbent 15 thereby producing a carbon dioxide stream that is considered not only hot but also wet. This high pressure high temperature carbon dioxide rich stream is withdrawn from the fixed sorbent bed 14 via line 13. The pressure in the fixed sorbent bed 14 during this phase is maintained at the desired pressure of the high purity and high pressure carbon dioxide product to be obtained—preferably at least in the range of from about 10 bar to about 30 bar. It is not until the carbon dioxide is released that the next phase, the rehydroxylation of the sorbent 15, takes place. More specifically, with regard to the sorbent 15, once the carbonate is formed in the sorption phase, the carbon dioxide can be released and the rehydoxylation can take place. In line with the previous example, this is demonstrated by the reactions as follows:

MgCO₃→MgO+CO₂

MgO+H₂O→Mg(OH)₂

As shown in this example, during the release phase, the magnesium carbonate is subjected to the noted temperatures (from about 350° C. to about 420° C.) to yield magnesium oxide and carbon dioxide. The temperature is maintained at this level for a period of time that is sufficient to allow for the release of the carbon dioxide. Once the carbon dioxide is released, for the rehydroxylation phase the temperature in the fixed sorbent bed 14 is then reduced using heat transfer media to a temperature from about 200° C. to about 300° C. in order to allow for the rehydroxylation of the sorbent 15. This phase occurs while the sorbent 15 in the fixed sorbent bed 14 is being contacted with steam or any other moisture containing stream. During the rehydroxylation phase, the magnesium oxide then reacts with water present (from the steam or other moisture containing stream) to yield magnesium hydroxide (a regenerated sorbent).

The next step of the present process as shown in FIG. 1 involves introducing the carbon dioxide depleted stream obtained in the first phase (the sorption phase) into a hydrogen pressure swing adsorption unit 11. The carbon dioxide depleted stream may be cooled (not shown) before entering the hydrogen pressure swing adsorption unit 11. The hydrogen pressure swing adsorption unit 11 utilized can be any hydrogen pressure swing adsorption unit known in the art. Methods for recovering hydrogen utilizing a pressure swing adsorption unit 11 are readily known to those skilled in the art. Accordingly, the present invention is not meant to be limited by the recovery of hydrogen utilizing a hydrogen pressure swing up sorption unit 11.

Finally, the purge effluent gas obtained from the carbon dioxide removal unit 8 is recycled along with the superheated steam used to purge the sorbent beds 14 to the syngas stream 5 that is to be introduced into the water gas shift reactor 6. Therefore, the purge effluent gas, which is also at high temperature/high pressure will generally not require further processing to be utilized as feed for the water gas shift reactor 6. Accordingly, this purge effluent gas does not have to be cooled or compressed, and the energy that is often lost from such streams is utilized in the shift reaction of the water gas shift reactor 6. As the syngas stream from the gasification unit 2 typically requires the addition of steam before it can be sent for carbon monoxide shift, a portion of the steam can be from the sorbent bed 14 being purged with the high pressure steam.

A still further embodiment of the present invention involves modifying the carbon dioxide removal unit 8 to allow for the recovery of the heat of sorption and the heat of rehydroxylation, or supply of heat for carbon dioxide release in the fixed sorbent beds 14. The modified carbon dioxide removal unit 8 would therefore comprise at least one fixed sorbent bed 14 that contains sorbent 15 and a heat transfer surface (not shown). The heat transfer surfaces would have a heat transfer media running therethrough. The heat transfer media enables heat exchange between the carbon dioxide removal unit 8 and the gasification unit 2. For example, when the fixed sorbent bed enters either the sorption phase or the rehydroxylation phase, this media could be run through the surfaces and allowed to remove the heat of sorption or the heat of rehydroxylation. Similarly, when the fixed bed enters the carbon dioxide release phase, the heat transfer media can provide the heat required for carbon dioxide release, source being hot syngas or water gas shifted gas. More specifically, the heated transfer media could be used to generate high pressure steam for the carbon dioxide removal unit 8 or the water gas shift reactor 6. A variety of different types of heat transfer media are available to be utilized in this manner. Examples of such heat transfer media include, but are not limited to, a molten carbonate salt mixture or any inorganic or organic compound with a boiling point that ranges from about 250° C. to about 350° C.

### ELEMENTS OF THE FIGURES

0—hydrocarbon feed stream source

1—line that provides hydrocarbon feed steams to high pressure gasification unit

2—high pressure gasification unit

3—line that provides sour syngas stream from the high pressure gasification unit to the sulfur removal unit

4—sulfur removal unit

5—line that provides essentially sulfur free syngas to the water gas shift reactor

6—water gas shift reactor

7—line that introduces water gas shift effluent into the carbon dioxide removal unit

8—carbon dioxide removal unit

9—line through which the high pressure superheated steam is introduced into the carbon dioxide removal unit

10—line through which the carbon dioxide depleted stream is introduced into the hydrogen pressure swing adsorption unit

11—hydrogen pressure swing adsorption unit

12—line by which the purge effluent gas is withdrawn from the carbon dioxide removal unit and recycled to the line that provides the syngas stream to the water gas shift reactor

13—line by which the high temperature/high pressure carbon dioxide purified stream is withdrawn

14—sorbent bed

15—sorbent

16—line from which hydrogen produced is withdrawn from the hydrogen pressure swing adsorption unit

17—purge surge drum

1. A process for recovering hydrogen and high temperature and high pressure carbon dioxide from one or more hydrocarbon feed streams, said process comprising:
a) introducing the one or more hydrocarbon feed streams into a high pressure gasification unit to produce a sour syngas stream that contains at least hydrogen, carbon monoxide, carbon dioxide, sulfur containing compounds, methane and water vapor;
b) subjecting the sour syngas stream to desulfurization in a sulfur removal unit to obtain an essentially sulfur free syngas stream;
c) subjecting the essentially sulfur free syngas stream to water gas shift in a water gas shift reactor to obtain a water gas shift effluent;
d) subjecting the water gas shift effluent to treatment in a carbon dioxide removal unit that contains one or more fixed sorbent beds, each fixed sorbent bed containing a sorbent that is highly selective for carbon dioxide and is selected from magnesium based sorbents, the treatment involving:
i) a sorption phase in which the water gas shift effluent is introduced into the one or more fixed sorbent beds at a temperature from 100° C. to 315° C. and a pressure from 10 bar to 60 bar thereby allowing for the carbon dioxide in the water gas shift effluent to selectively react with the sorbent as the effluent passes through the one or more fixed sorbent bed while a portion of the remaining components of the water gas shift effluent are nonspecifically trapped in the void spaces in the sorbent and the remaining portion of the components of the water gas shift effluent is discharged from the one or more fixed sorbent bed as a carbon dioxide depleted stream,
ii) a purge phase in which the one or more fixed sorbent bed is purged of the components of the water gas shift effluent that are nonspecifically trapped in the void spaces in the sorbent by introducing a high pressure superheated steam to produce a purge effluent gas that is discharged from the one or more fixed sorbent bed;
iii) a carbon dioxide release in which the temperature of the one or more fixed sorbent bed is increased to a temperature of between 350° C. and 420° C. using superheated steam and indirect heat to allow for the release of the carbon dioxide from the sorbent thereby producing a wet, high temperature carbon dioxide rich stream that is discharged from the one or more fixed sorbent bed; and
iv) a rehydroxylation phase in which the temperature of the one or more fixed sorbent bed is reduced to from about 200° C. to 300° C. while at the same time contacting the one or more fixed sorbent bed with steam or any other moisture containing stream to allow for the rehydroxylation of the sorbent;
e) recycling the purge effluent gas along with the high pressure superheated steam to the syngas stream that is to be introduced into the water gas shift reactor unit;
f) passing the wet, high pressure carbon dioxide rich stream on for further use; and
g) introducing the carbon dioxide depleted stream obtained into a pressure swing adsorption unit to allow for the recovery of a high purity gaseous hydrogen stream.

2. The process of claim 1, wherein the gasification unit is a coal gasification unit.

3. The process of claim 1, wherein the carbon dioxide removal unit contains more than one fixed sorbent bed wherein the beds are configured in such a manner that there is always at least one bed in each phase at a given time.

4. The process of claim 1, wherein the carbon dioxide removal unit contains multiple sorbent beds in each phase.

5. The process of claim 1, wherein the sorbent used in the one or more fixed sorbent beds is magnesium hydroxide.

6. The process of claim 1, wherein the purge phase pressure is higher than the pressure in the water gas shift reactor, enabling the purge stream to feed into the water gas shift reactor without further compression.

7. The process of claim 1, wherein during the release of the carbon dioxide during the release phase, the temperature of the fixed sorbent bed is from about 375° C. to about 420° C.

8. The process of claim 1, wherein each of the fixed sorbent beds includes a means for heating and cooling the fixed sorbent bed.

9. The process of claim 8, wherein the means for heating and cooling the fixed sorbent bed comprises a set of heat transfer surfaces imbeded in each sorbent bed, the heat transfer surfaces having disposed therein a heat transfer media which becomes heated due to the heat generated during sorption and rehydroxylation, or cooled due to heat required during carbon dioxide release.

10. The process of claim 9, wherein the heat transfer media is used to generate high pressure steam for the carbon dioxide removal unit or as a source of heat for the high pressure gasification unit.

11. The process of claim 9, wherein the heat transfer media is used to transfer heat from high pressure gasification unit or water gas shift to heat the sorbent bed in carbon dioxide release phase.

12. The process of claim 9, wherein the heat transfer media is molten carbonate salt mixture.

13. The process of claim 9, wherein the heat transfer media is an inorganic or organic compound with a boiling point that ranges about 250° C. to about 350° C.

14. A process for recovering hydrogen and high temperature and high pressure carbon dioxide from one or more hydrocarbon feed streams, said process comprising:
a) introducing the one or more hydrocarbon feed streams into a high pressure gasification unit to produce a syngas stream that contains at least hydrogen, carbon monoxide, carbon dioxide, methane and water vapor;
b) subjecting the syngas stream to water gas shift in a water gas shift reactor to obtain a water gas shift effluent;
c) subjecting the water gas shift effluent to treatment in a carbon dioxide removal unit that contains one or more fixed sorbent beds, each fixed sorbent bed containing a sorbent that is highly selective for carbon dioxide and is selected from magnesium based sorbents, the treatment involving:
i) a sorption phase in which the water gas shift effluent is introduced into the one or more fixed sorbent beds at a temperature from 100° C. to 315° C. and a pressure from 10 bar to 60 bar thereby allowing for the carbon dioxide in the water gas shift effluent to selectively react with the sorbent as the effluent passes through the one or more fixed bed while a portion of the remaining components of the water gas shift effluent are nonspecifically trapped in the void spaces in the sorbent and the remaining portion of the components of the water gas shift effluent is discharged from the one or more fixed bed as a carbon dioxide depleted stream,
ii) a purge phase in which the one or more fixed bed is purged of the components of the water gas shift effluent that are nonspecifically trapped in the void spaces in the sorbent by introducing a high pressure superheated steam to produce a purge effluent gas that is discharged from the one or more fixed bed;
iii) a carbon dioxide release in which the temperature of the one or more fixed bed is increased to a temperature of between 350° C. and 420° C. using superheated steam and indirect heat to allow for the release of the carbon dioxide from the sorbent thereby producing a wet, high temperature carbon dioxide rich stream that is discharged from the one or more fixed bed; and
iv) a rehydroxylation phase in which the temperature of the one or more fixed bed is reduced to from about 200° C. to 300° C. while at the same time contacting the one or more fixed bed with steam or any other moisture containing stream to allow for the rehydroxylation of the sorbent;
d) recycling the purge effluent gas along with the high pressure superheated steam to the syngas stream that is to be introduced into the water gas shift reactor unit;
e) passing the wet, high pressure carbon dioxide rich stream on for further use; and
f) introducing the carbon dioxide depleted stream obtained into a pressure swing adsorption unit to allow for the recovery of a high purity gaseous hydrogen stream.

15. The process of claim 14, wherein the gasification unit is a coal gasification unit.

16. The process of claim 14, wherein the carbon dioxide removal unit contains more than one fixed sorbent bed wherein the beds are configured in such a manner that there is always at least one bed in each phase at a given time.

17. The process of claim 14, wherein the carbon dioxide removal unit contains multiple sorbent beds in each phase.

18. The process of claim 14, wherein the sorbent used in the one or more fixed sorbent beds is magnesium hydroxide.

19. The process of claim 14, wherein the purge phase pressure is higher than the pressure in the water gas shift reactor, enabling the purge stream to feed into the water gas shift reactor without further compression.

20. The process of claim 14, wherein during the release of the carbon dioxide during the release phase, the temperature of the one or more fixed bed is from about 375° C. to about 420° C.

21. The process of claim 14, wherein each of the one or more fixed beds includes a means for heating and cooling the one or more fixed bed.

22. The process of claim 21, wherein the means for heating and cooling the one or more fixed bed comprises a set of heat transfer surfaces imbeded in each sorbent bed, the heat transfer surfaces having disposed therein a heat transfer media which becomes heated due to the heat generated during sorption and rehydroxylation, or cooled due to heat required during carbon dioxide release.

23. The process of claim 22, wherein the heat transfer media is used to generate high pressure steam for the carbon dioxide removal unit or as a source of heat for the gasifier process.

24. The process of claim 22, wherein the heat transfer media is used to transfer heat from gasifier or water gas shift to heat the sorbent bed in carbon dioxide release phase.

25. The process of claim 22, wherein the heat transfer media is molten carbonate salt mixture.

26. The process of claim 22, wherein the heat transfer media is an inorganic or organic compound with a boiling point that ranges about 250° C. to about 350° C.
